(19) United States
(12) Patent Application Publication
(10) Pub. No.: US 2021/0081426 A1
(43) Pub. Date: Mar. 18, 2021

(54) FOOD ORDERING SYSTEM AND METHOD

(71) Applicant: Foodee Inc, Vancouver (CA)

(72) Inventors: Joseph Gaudet, Vancouver (CA); Patrick Frost, Coquitlam (CA); James Christopher Romanchuk, Vancouver (CA); Arthur Champoux Goldsmith, Vancouver (CA)

(21) Appl. No.: 17/022,040

(22) Filed: Sep. 15, 2020

Related U.S. Application Data
(60) Provisional application No. 62/900,624, filed on Sep. 15, 2019.

(51) Int. Cl. G06F 16/2457; G06F 16/248; A23L 5/10

(52) U.S. Cl. CPC G06F 16/24578; A23L 5/10; G06F 16/248; G06F 16/24573

(57) ABSTRACT

A system and method for ordering and scheduling food orders. The system considers hard and soft requirements for one or more customers, a restaurant's capacity to serve assigned meals, and restaurant variety. The system and method may automatically select menu items from assigned restaurants based on food requirements and amount of food required.

### CROSS-REFERENCE TO RELATED APPLICATIONS

This Application claims priority to U.S. Provisional Application No. 62/900,624, filed Sep. 15, 2019, hereby incorporated by reference in its entirety.

### FIELD OF INVENTION

The invention relates to online food ordering, in particular computer implemented ways of scheduling and optimizing food ordering.

### BACKGROUND

Systems for e-commerce food delivery currently match users to a restaurant and may provide a service to deliver the food to the user. The methods of matching are typically manual and driven by the user searching through an online catalogue of potential restaurants and selecting a restaurant and menu items to be delivered.

Some automated systems exist that simply match keywords to menu or restaurant tags. While this satisfies the simple case of matching a single user to multiple restaurants, it does not incorporate enough conditions to be met or scale well to thousands of users and restaurants simultaneously.

This method becomes considerably more complex when endeavouring to plan a meal for multiple users, managing their various dietary requirements and meal preferences. The problem becomes geometrically complex when planning multiple orders for multiple groups of users simultaneously. This is due to the concurrent nature of the schedules, this requires considering restaurant availability, capacity, and utilization. All while ensuring that groups receive an ever-changing variety of options that meet their needs. The problem is two-fold, concurrently selecting an available valid restaurant for all groups simultaneously, and further selecting menu items automatically for all users inside of those groups.

### SUMMARY OF THE INVENTION

In accordance with a first aspect of the invention there is provided a computer-implemented method of creating a food order to a plurality of customers comprising the steps of: providing a datastore of customer groups and their associated soft and hard requirements, which customer groups are each associated with plural users; providing a datastore of restaurants, each restaurant associated with food tags; searching the datastore of restaurants for candidate combinations of restaurants that solve the hard requirements for each customer based on the restaurants' food tags; ranking the candidate combinations based on a weighting of each customer groups' soft requirements; and outputting the highest ranked combinations of restaurants for each customer group as a food order.

In accordance with a second aspect of the invention there is provided a computer-implemented method of automating meal selection comprising: receiving hard and soft meal requirements for each of multiple customers; a solver applying hard meal requirements to determine eligible restaurant-customer tuples; the solver applying hard meal requirements to automatically select menu items associated in a database with restaurants of the eligible restaurant-customer tuples.

In accordance with a third aspect of the invention there is provided a method of selecting meal items for a group of people in a single order comprising: determining a budget for the order; providing a datastore of menu items for one or more selected restaurant(s), which datastore comprises a cost and meal size for each menu item; and determining a subset of the menu items that maximizes the total meal size and having a total cost less than the budget for the order.

In accordance with a fourth aspect of the invention there is provided a meal selection system comprising: a datastore of customer groups and their associated soft and hard requirements; a datastore of restaurants, each restaurant associated with food tags; a memory storing instructions; and a processor operatively coupled to the memory to execute the instructions to implement any of the above methods.

### BRIEF DESCRIPTION OF THE DRAWINGS

Various objects, features and advantages of the invention will be apparent from the following description of embodiments of the invention, as illustrated in the accompanying drawings.

FIG. 1 is a System Diagram, showing high-level interactions between subsystems.

FIG. 2 is a Sequence Diagram of interaction between each of the supporting subsystems and the meal planner.

FIG. 3A is a User Interface for scheduling plan templates in which a planner can manage many customers simultaneously, before restaurants have been assigned to all of the slots.

FIG. 3B is a User Interface after a single plan has been solved.

FIG. 4 is a Class Diagram of the data structures involved in organizing the problem of planning meals.

FIG. 5 is a Workflow Diagram that an account planner would go through to set up and automate a customer's meal plan.

FIG. 6 is a Restaurant Assignment Flow for applying constraints to a plan or collection of plans.

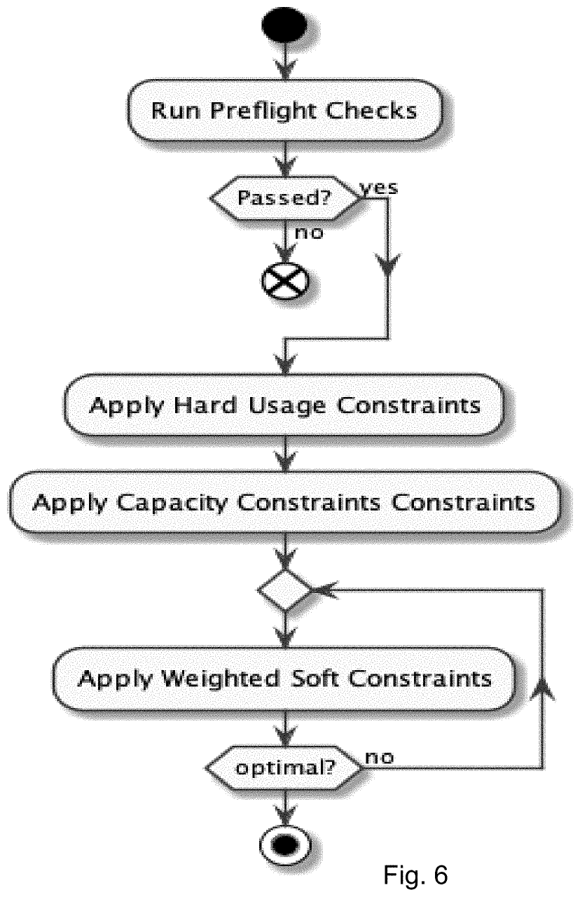

FIG. 7 is a diagram of meal slots.

### DESCRIPTION OF THE INVENTION

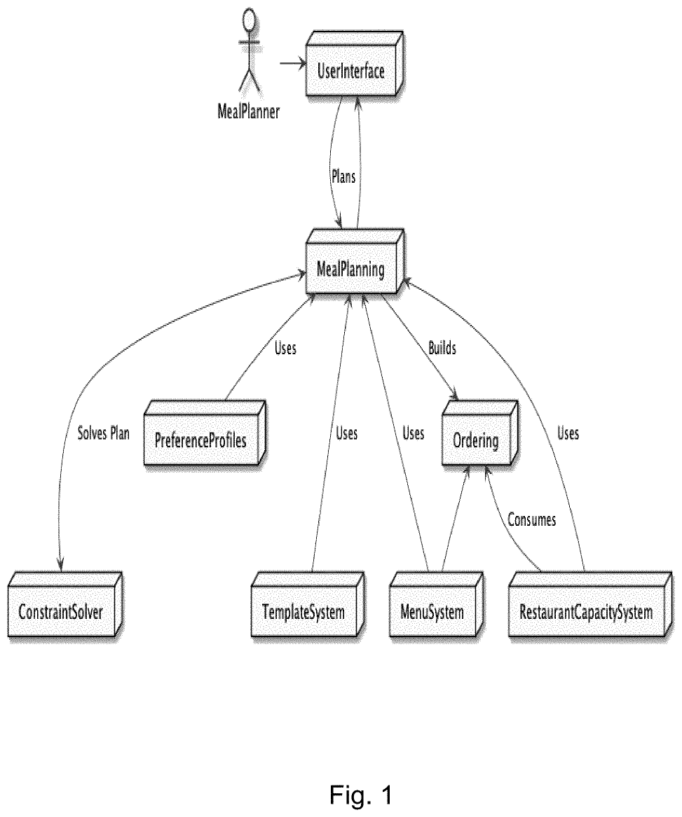

In accordance with preferred embodiments of the invention, there is a system and method that automates meal planning, in particular optimizing matching multiple customers to multiple restaurants. The system and method may also optimize an individual meal request for a given budget. The system comprises a plurality of customer computing devices (aka ‘Customers’), plurality of restaurant computing devices (aka ‘Restaurants’) and one or more servers for receiving meal request, matching requests and communicating the results as orders to restaurant computing devices. FIG. 1 illustrates high-level interactions between the various subsystems of the server.

### Glossary

Customer: an entity representing plural people.

Restaurant constraint: a constraint selected by a user to select restaurants

Menu: a list of all food items purchasable from that restaurant.

Meal item: a food item on a menu.

Meals are collections of slots, which contain assignment variables for each potential restaurant.

User: a person that interacts with a computing device to input meal requests or receive meal orders.

Hard requirement: a value that must be satisfied when assigning restaurants or meals items.

Soft Requirements: a value that improves the match score for restaurants or menu items when matched.

Subsystems: a logically divided block, function or module in software to accomplish some function or task. A subsystem implemented in one or more software objects, run on one or more processors or threads. A subsystem may also be a datastore to hold a particular set of data, regardless of whether it is implemented over several physical memory units or shared by other datastores.

The method preferably uses a Boolean satisfaction algorithm in order to create an optimal pairing of customers and restaurants based on several factors, including one or more of: matching dietary requirements of people; novelty of restaurant selection and selection of customer favourites; and ensuring restaurants have capacity;

The system may automatically select menu items for each person in the customer group, based on several constraints, including: each person's dietary requirements; the customer's budgetary requirements; and popularity of the item (globally or within that customer's persons).

The meal planning system is supported by several subsystems (datastores and functions) that are employed for its function (see FIG. 1). A datastore may store for each restaurant capacity (meal items per hour or units of meal item effort per unit time) and menu tags.

A Menu Meta Tagging subsystem, which provides meta information with respect to a menu item including: type of dish (entree, appetizer, etc); type of food (pizza, noodles, etc); dietary information (gluten-free, nut-free, etc); serving sizes; kitchen Capacity Effect (how hard is it for a kitchen to make this item); table of possible modifications to menu items.

A datastore records for each customer hard and soft requirements such as: dietary information (gluten-free, nut-free, etc); meal type preferences; meal slot times; budget; number of people in the group, and history of past orders.

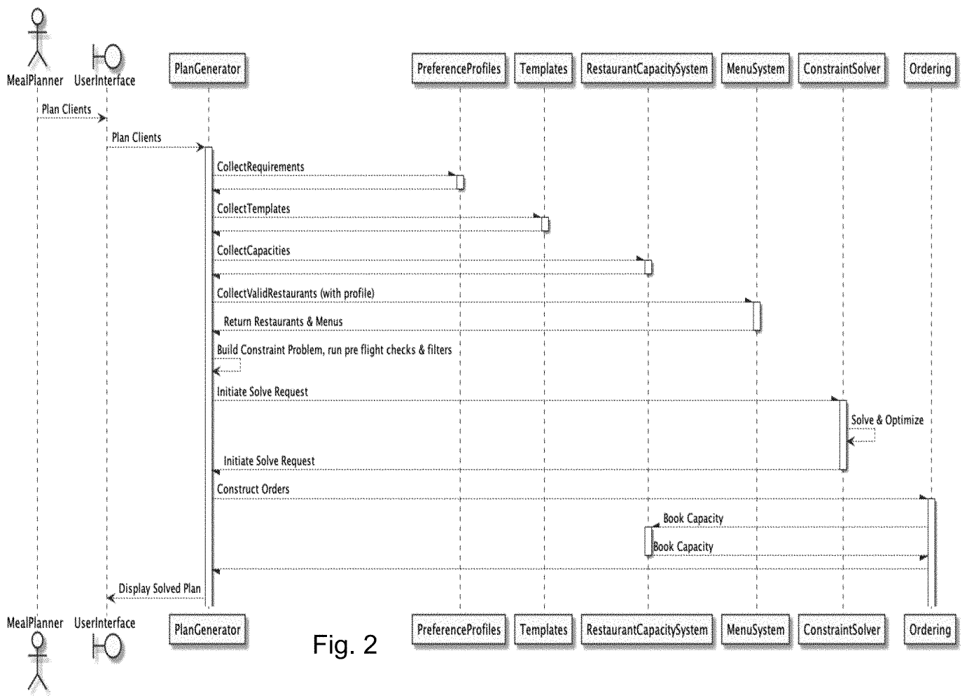

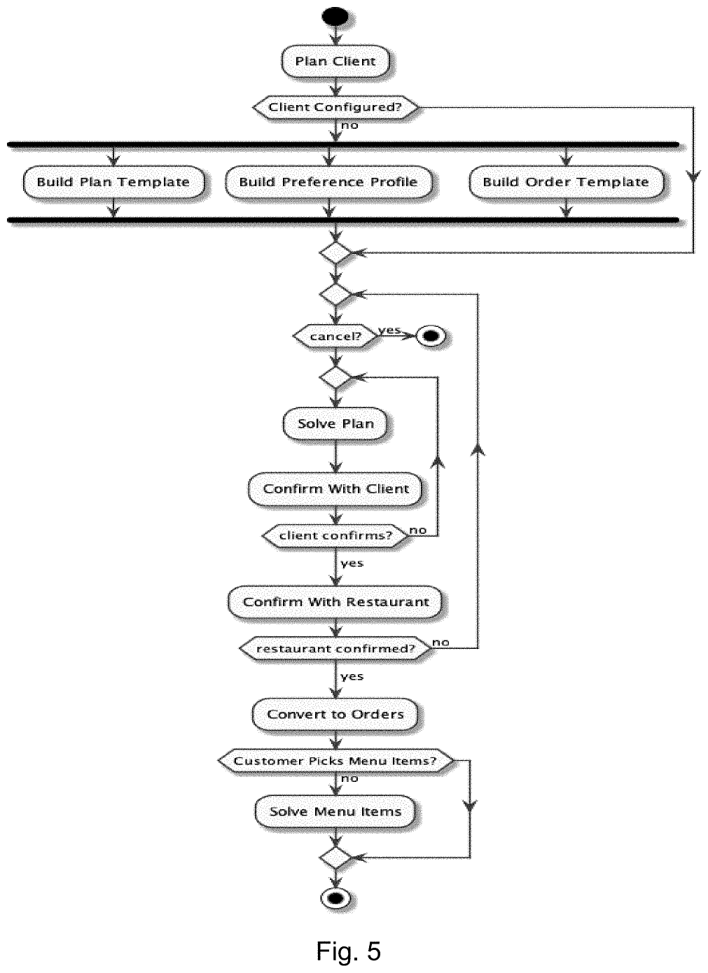

Automated meal planning is broken down into three activities (shown in FIG. 5 and FIG. 2): requirements Collection; constraint solving for restaurant selection; and constraint solving for individual menu item selection.

A user interface operable by a user on the customer computing device provides a means of collecting hard and soft requirements to be stored in memory and associated with that customer for future computations. Requirements may be collected from each user within the customer's group (and later aggregated) or as a global requirement for the customer entered by a single user.

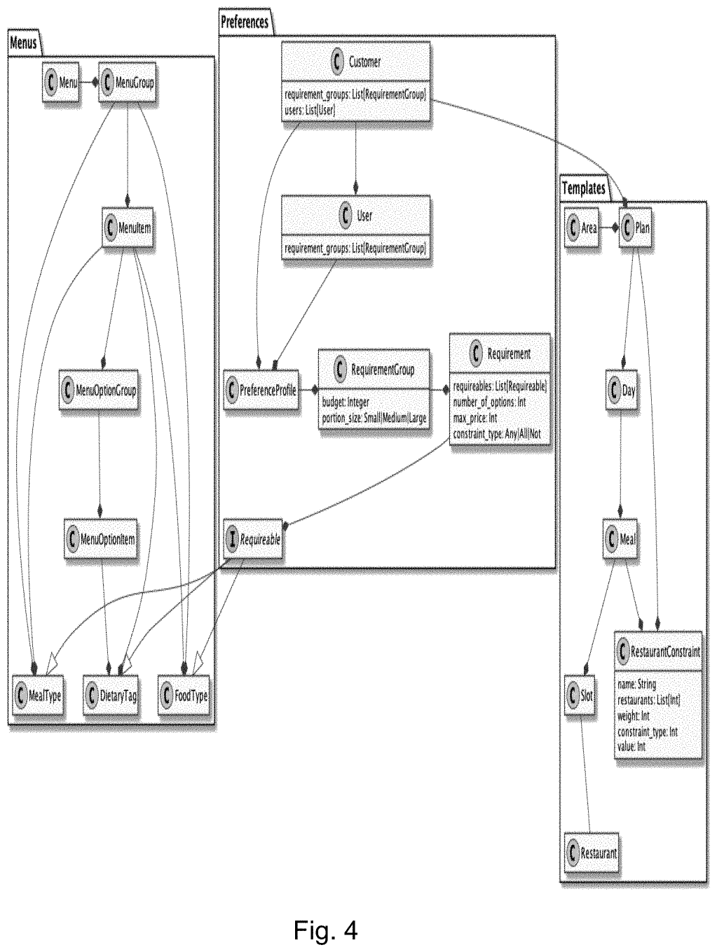

The system may store meal templates with preferences for each customer in a datastore, which the processor loads as the default structures to begin finding candidate restaurants. FIG. 4 shows a Class Diagram for the data structures involved in organizing the problem of planning meals. Specifically, this diagram shows the menu tagging, preferences, and template subsystems.

Meal templates are weekly schedules of when and from how many restaurants a given customer will normally order food. Templates may comprise days, meals, meal slots and restaurant frequency (see FIG. 4 Templates Section):

A day represents a single day of the week in a plan, which may have zero or more meals and zero or more restaurant constraints

A meal is a single food service (e.g. breakfast, lunch, dinner) which is composed of one or more restaurant slots (depending on the number of people that the meal must accommodate) and zero or more restaurant constraints

A slot is a placeholder for a single restaurant assignment.

A restaurant frequency is a collection of potential restaurants and (hard or soft) frequency values. When a constraint is soft, it is accompanied by a weight which expresses the ratio of how often it should be selected. When a constraint is hard, it is accompanied by a value and a comparator, this value and comparator expresses a minimum, maximum, or exact amount of times a single restaurant is selected either for a single meal or a single day.

Customer food preferences (aka soft requirements), these can be wide-ranging and may include the categories: Meal Types (entrees, appetizers); Food Types (Bowls, Soups, Pizza); Dietary Requirements (Gluten Free, Nut Free, Dairy Free); Budgetary Requirements; Variety (number of options).

Preferences are captured on a per-person and per-customer level, where a single customer's food preferences are aggregated from one or more people (Shown in FIG. 4 in the preferences package).

The system may treat restaurant selection as a scheduling problem, in which there are n restaurant slots to which we must assign m restaurants while ensuring that the restaurants have not exceeded their capacity for given time of day, as slots from multiple client plans may have meals at the same day and time.

Before committing a plan to the solver, several pre-flight checks are run to ensure that a plan has a feasible solution. These checks include a) ensuring that every meal is contained by n restaurant's service times, where n is the number of slots that the meal has and b) ensuring that all hard constraints are valid, which is to say the number of available restaurants satisfies the min, max, or equality defined by the value and comparator.

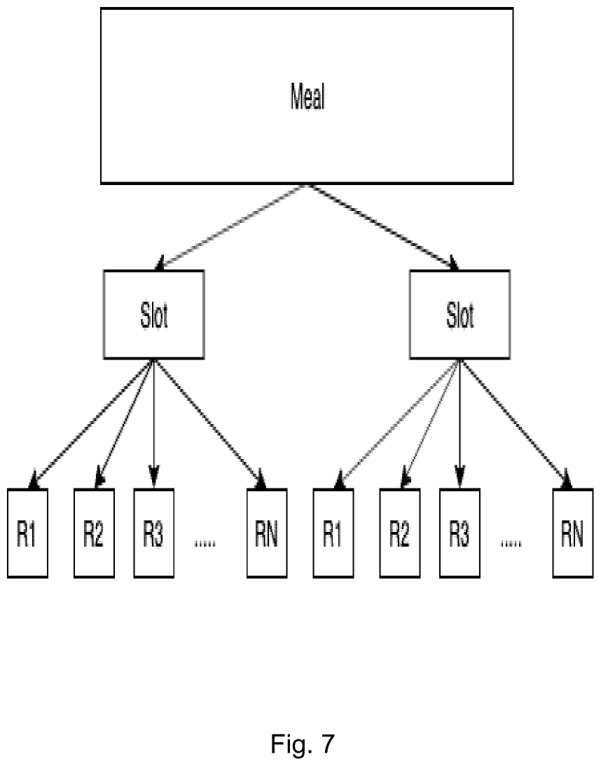

Assignments in the solver are represented as Boolean variables that are addressed as a tuple of a slot and a restaurant. Each slot in a plan has a Boolean assignment variable for each restaurant that could possibly be used in that slot (See: FIG. 7). Hard usage constraints are then applied by summing those Boolean assignments (true for assigned is coerced into a 1, while false for unassigned is coerced into a 2) and enforcing the comparator constraints.

Some examples of usage constraints include: a) The sum of all assignment variables for a given slot must equal one; b) For all restaurants, the sum of their assignment variables for a given meal must be less than or equal to 1 (can be configured); c) for all restaurants, the sum of their assignment variables for a given meal must less be than or equal to 1 (can be configured); d) User-provided constraints, the sum of usage from a particular restaurant(s) must be less than, greater than, or equal to some provided value

There may be many valid combinations of restaurants for each customer, for each meal. These candidate combinations may be subject to further constraints and rankings.

Capacity constraints are related to a restaurant's ability to handle multiple large orders. For example, a restaurant may only be able to make 50 meals and so a slot that has 80 people would not be a suitable match for that slot. Each restaurant has T capacity tranches per day, each with a start time, end time, and capacity number. For each capacity tranche, the sum of the product of each restaurant assignment variable and the slot's number of people for all slots that have a delivery time that falls in the tranche must be less than the capacity number for that tranche. That is the restaurant must have the capacity to make the number of menu items expected to be ordered for lunch (or for dinner).

The solver may monitor whether a given restaurant would be overcapacity, when assigning slots, and then stop adding overcapacity restaurants to the set of candidates once their capacity has been reached. Alternatively, the solver may compute overcapacity after creating the set of candidate combinations and then remove candidate combinations that include overcapacity restaurants.

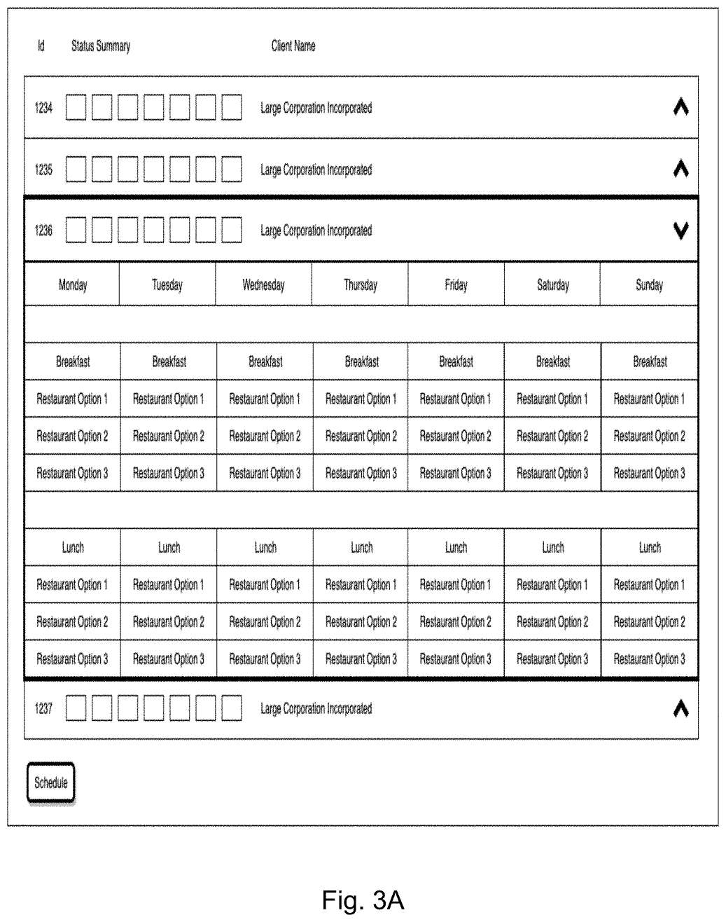

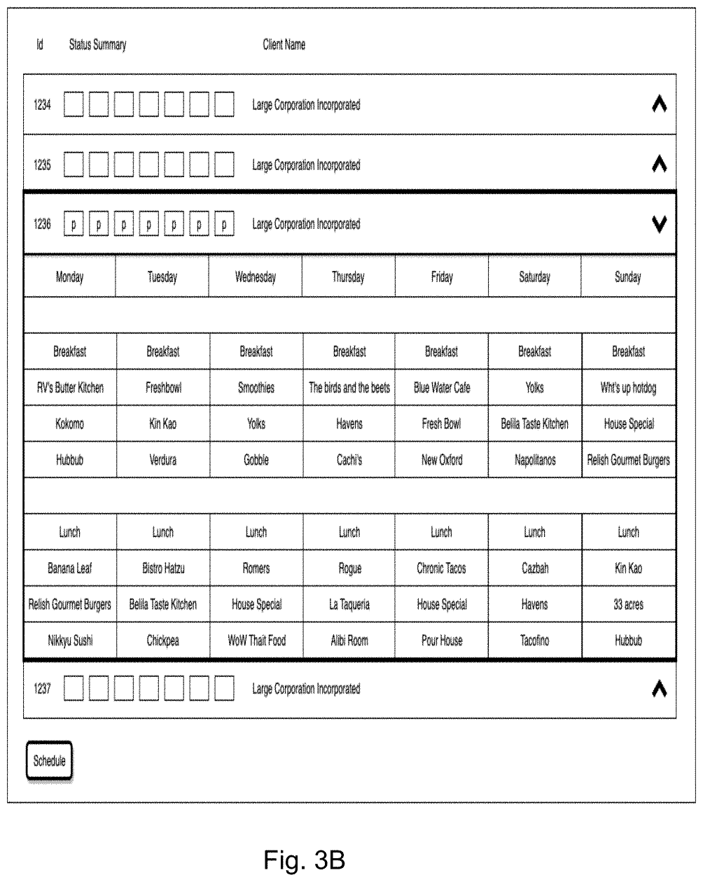

FIG. 3A is a User Interface for scheduling plan templates in which a planner can manage many customers simultaneously, before restaurants have been assigned to all of the slots. FIG. 3B is a User Interface after a single plan has been solved, no specific restaurants have been assigned, as well as the status indicators have been set to planned.

Optimizing Weighted Restaurant Constraints (soft)

Weighted constraints are used to improve the quality of a solution. The system provides an objective function which the solver can endeavour to maximize. A single weighted constraint value is the sum of its restaurant assignments in either a plan, day or meal multiplied by its weighting. Therefore, the overall objective function is the sum of each weighted constraint's value. The solver then uses this objective function to search the solution space of hard constraints for the solution with the greatest value.

An example objective function is as follows:

ΣLastWeekRestaurants*−1+ΣFavouriteRestaurants*2+ΣNewRestaurants*2

For example, once this objective function has been maximized, it may be declared optimal. Alternatively, the objective function could minimize sum of distances between customers and restaurants, maximize nutritional matching of menu items to customer preferences

Restaurant Popularity is a weighted soft constraint that may be incorporated into the solver as another objective function, maximizing the total restaurant popularity score. In the datastore each restaurant is associated with a ranking score, the ranking represents how frequently they are selected by customers. Higher number are more popular across all customers.

### Automated Menu Item Selection

In some embodiments, the processor selects not only the restaurants but the menu items as well. Menu Item selection may be implemented using solutions to the “knapsack problem”, in which there are Q user carts (knapsacks), which must be filled with items that match the dietary, meal, and food requirements while not exceeding the budgetary requirements of the user. As shown in FIG. 4, menu items are annotated with Meal Types, Food Types, and Dietary Tags. In addition to this menu items have serving quantities defined, as well as the modifiers that can change the dietary tagging of items. For instance, substituting a hamburger bun for a gluten-free bun will make a burger gluten-free. Multiple variants of a burger are generated, preferably as a truth table. The process filters only the combinations (substitutions) that are necessary for a given requirement.

So a combination may have the properties of GF+DF, but if the requirement is GF only, that combination will not be included.

For each requirement in each cart (knapsack) valid menu items from a restaurant are selected including menu items that may need to be modified in order to match their requirements. Before committing these requirements to the solver, they are each validated to ensure that there is an appropriate number of items.

In the simplest situation the solver optimizes for a single person, whereby serving knapsacks are filled with items with a serving number of 1. The constraint solver imposes the hard constraint, that the sum of the items in the cart must be less than or equal to the cart's budget (here the budget is the money equivalent of the knapsack space). This is achieved by creating boolean assignment variables for each menu item (as in the restaurant selection case) and enforcing that the sum of those variables times their price is less than the budget.

In one embodiment, plural people are considered by filling knapsacks with menu items, each item having a range of serving numbers (e.g. serves 4-6 people). In the case of these knapsacks, rather than boolean assignment variables, an integer assignment variable is used which represents the number of items placed in a cart, this number is multiplied by the serving number which in turn applies the following constraints based on a variable portion size.

The variable portion size sets the serving size from between a stored maximum to minimum value then the solver applies the constraint that the sum of the product of the serving size of a menu item and its integer assignment variable be less than or equal to the number of people that the knapsack applies to.

As in the restaurant selection solver, the system uses an objective function to find the optimal solution to the knapsack problems. In the case of menu item selection, the solver uses the minimization of the price as an objective function, to find the lowest cost solution for customers.

The Menu Meta Tagging subsystem may use clustering, to assign tags automatically to restaurants. This subsystem may use a restaurant's menu item tags (Sandwich, Pizza, etc), and their cuisine tags (Thai, Italian, Hearty etc) as inputs to existing clustering algorithms which then defines and output a cluster value. For unlabeled data, it is preferable to use K-Means clustering algorithm to assign restaurants to one of N unlabeled restaurant clusters. The restaurant clustering may be updated on a regular basis. The solver then uses this clustering number to ensure that individual meals, days, day-day pairs, and weeks have a solution that is as homogenous as possible, which means that it picks evenly from all clusters. The homogeneity may be maximized with an entropy objective function.

Since this clustering can cause solutions to be more infeasible, the solver may successively back them off if no valid solution can be found. The solver may be re-run without cluster homogeneousness enforced. For example the solver may first allow for the week to be not homogenous, then allow the day to day pairs to be non homogenous, then turn off the requirement all together. The number of clusters may also be varied to enable more valid solutions.

Tags have a type and quantity to form a vector that defines the item's ‘composition’. For menu items, they may be between 0-1 to define what percentage of a resturant's menu items are a particular tag.

For example, if a menu had four items, and three of them were sandwiches and one of them was salad, the dimensionality vector would be: [sandwich: 0.75, salad: 0.25]. Similarly the menu may be tagged with the cuisine of Vietnamese to create another component of the vector.

1. A computer-implemented method of creating a food order to a plurality of customers comprising the steps of:
providing a datastore of customer groups and their associated soft and hard requirements, which customer groups are each associated with plural users;
providing a datastore of restaurants, each restaurant associated with food tags;
searching the datastore of restaurants for candidate combinations of restaurants that solve the hard requirements for each customer based on the restaurants' food tags;
ranking the candidate combinations based on a weighting of each customer groups' soft requirements; and
outputting the highest ranked combinations of restaurants for each customer group as a food order.

2. The method of claim 1, further storing a history of prior food orders for each customer.

3. The method of claim 1, further comprising storing restaurant repetition rates for each customer group

4. The method of claim 1, wherein each restaurant is further associated with a meal capacity, and
further comprising determining which restaurants are over capacity based on the candidate restaurants, then removing certain candidate combinations that include overcapacity restaurants.

5. A computer-implemented method of automating meal selection comprising:
receiving hard and soft meal requirements for each of multiple customers;
a solver applying hard meal requirements to determine eligible restaurant-customer tuples;
the solver applying hard meal requirements to automatically select menu items associated in a database with restaurants of the eligible restaurant-customer tuples.

6. The method of claim 5, further comprising retrieving a meal template from a datastore, the template including one or more defined meals, each meal comprising one or more meal slots.

7. The method of claim 5, further comprising applying a weighting algorithm to determine optimal assignment of restaurants to meal slots for each customer using the soft constraints for each customer

8. The method of claim 5, wherein the weighted algorithm employs an objective function to maximize variety in restaurants assignments to each customer.

9. The method of claim 5, wherein scheduling meals is performed over multiple meal slots for the multiple customers,
the solver further applying frequency constraints that limit how often any restaurant may be assigned to a given customer over the multiple slots.

10. A meal selection system comprising: a datastore of customer groups and their associated soft and hard requirements; a datastore of restaurants, each restaurant associated with food tags; a memory storing instructions; and a processor operatively coupled to the memory to execute the instructions to:
search the datastore of restaurants for candidate combinations of restaurants that solve the hard requirements for each customer based on the restaurants' food tags;
rank the candidate combinations based on a weighting of the customers' soft requirements; and
output the highest ranked combinations of restaurants for each customer as a food order.

11. The meal selection system of claim 10, the datastore of customer groups further storing a history of prior food orders for each customer.

12. The meal selection system of claim 10, a datastore of customer groups further comprising restaurant repetition rate for each group.

13. The meal selection system of claim 10, wherein each restaurant is further associated with a meal capacity, the processor further determining which restaurants are over capacity based on the candidate restaurants, then removing certain candidate combinations that include overcapacity restaurants.
